(19) United States
(12) Patent Application Publication
(10) Pub. No.: US 2015/0336613 A1
(43) Pub. Date: Nov. 26, 2015

(54) DEVICE FOR CHANGING THE RIGIDITY OF A VEHICLE, METHOD FOR ACTIVATING A DEVICE FOR CHANGING THE RIGIDITY OF A VEHICLE AND CONTROL UNIT

(71) Applicant: Robert Bosch GmbH, Stuttgart (DE)

(72) Inventors: Thomas Friedrich, Freiberg A.N. (DE); Gian Antonio D'Addetta, Stuttgart (DE)

(73) Assignee: Robert Bosch GmbH, Stuttgart (DE)

(21) Appl. No.: 14/410,312

(22) PCT Filed: May 22, 2013
(86) PCT No.: PCT/EP2013/060457

§ 371 Date: Dec. 22, 2014

(30) Foreign Application Priority Data
Jun. 25, 2012 (DE) 10 2012 210 680.4

(51) Int. Cl. B62D 21/15

(52) U.S. Cl. CPC B62D 21/152

(57) ABSTRACT

A device for changing the rigidity of a vehicle includes: at least one frame side member; and an adaptive element having at least two fastening points, one of the at least two fastening points being connected to the at least one frame side member. The adaptive element is aligned transversely to the at least one frame side member, and the adaptive element has an actuator including an interface for receiving a triggering signal for operating the actuator. The actuator is configured to change the rigidity of the adaptive element in response to the triggering signal.

### BACKGROUND OF THE INVENTION

1. Field of the Invention

The present invention relates to a device for changing the rigidity of a vehicle, a method for activating a device for changing the rigidity of a vehicle, to a corresponding control unit, as well as to a corresponding computer program product.

2. Description of the Related Art

The greatest proportion of vehicles to be built currently and in the near future will be based on an internal combustion engine. It is known that, besides the massive engine block that is to be regarded as rigid, the engine compartment in modern vehicles is filled with many assemblies (ESP, air conditioning compressor, water pump, generator, etc.). Assemblies which are developed to be space-saving, compared to predecessor models are gratefully accepted. This also applies to larger vehicles. Even when more space is available in the engine compartment, there tend to be more assemblies onboard, so that in this case too there is a lack of space. This state of the art is also distinctive in a frontal crash, in a particular manner. The rigidity of the front section should not only be defined by the rigidity of the frame side member itself. Other aspects, such as the displacing of the engine, the compressing of the assemblies and the interlocking of all the elements in the engine compartment lead to an effective crash rigidity, which is greater than the actual rigidity of the frame side member. To put it another way: If the rigidity of the frame side members would suddenly drop down to an extreme extent during a crash, this would have only a relatively slight effect since the engine and the assemblies would continue to be present and would stiffen the vehicle during the crash. Above all, in electric vehicles, whose sales volume will keep rising in the next decades, the space problems of the internal combustion engine and their assemblies are not relevant. In electric vehicles, the electric motor is quite small, first of all, and secondly is installed rather far below, the low installation location having a positive effect on the center of gravity position.

### BRIEF SUMMARY OF THE INVENTION

The present invention provides a device for changing the rigidity of a vehicle, a method for activating a device for changing the rigidity of a vehicle, and furthermore a corresponding control unit which uses this method, and finally a corresponding computer program product.

By having fewer assemblies in the motor compartment and a deeper installation position of the electric motor, the energy of impact during a crash affects the frame side member to a greater extent than in conventional vehicles. This yields the fact that the frame side members in an electric vehicle or vehicles having similar impact characteristics should absorb the major part of the impact energy and, because of the lacking support possibilities in the front section, are more susceptible to buckling. For example, a vehicle has a controlled deformation of the front structure, adapted to the type of impact and, at the same time or alternatively, to the severity of the impact.

The present invention creates a device for changing the rigidity of a vehicle, the device having at least one frame side member, the device having the following feature: an adaptive element, the adaptive element having at least two fastening points; at least one fastening point of the at least two fastening points being connected to the at least one frame side member; the adaptive element being aligned transversely to the at least one frame side member; the adaptive element having an activator having an interface for receiving a triggering signal for operating the activator; the activator being developed to change the rigidity of the adaptive element in response to the triggering signal.

The device may be used in a vehicle for the absorption of crash energy due to a collision of the vehicle with an additional vehicle, for example, or with a stationary object, and acting upon the vehicle and its passengers. The device may be positioned in the front section of the vehicle. The vehicle may be a passenger car or a commercial vehicle such as a truck. The collision may be an impact of the vehicle on an unmoved object or a collision with a moved object, such as at least one second vehicle. By an impact, one may generally also understand a crash. In this context, the collision may take place in a frontal manner. In this context, the collision may take place in a fully overlapping and/or a partially overlapping manner. By a fastening point, one may understand a region in which the frame side member and the adaptive element are connected to each other and/or are in contact with each other. An adaptive element may have at least two different rigidities. In the case of a high impact speed and thus high collision energies, in the case of a fully overlapping impact, it is advantageous to reach a high energy absorption level early, which is why generally a higher rigidity is set in standard fashion. In the case of a partially overlapping impact, a lower rigidity is required, so that the rear, more rigid structure is not stressed too greatly. Correspondingly, the attractive element in the second setting has a rigidity which is lower than the rigidity described first. The two rigidities may be set by an actuator. The adaptive element is able to adapt the lateral rigidity between the individual frame side members or rather between a frame side member and the chassis of the vehicle.

Corresponding to a further specific embodiment of the present invention, the at least one frame side member may have a section which has a lower rigidity compared to a further section of the at least one frame side member. The lower rigidity of the section of the frame side member may be achieved, for example, by a tapering, that is, a reduction in the cross section of the frame side member, by notching, by removing stiffening ribs, by indenting or the like.

Moreover, one fastening point of the at least two fastening points may be connected to the at least one frame side member and an additional fastening point of the at least two fastening points may be connected to a further fastening point, the at least one frame side member and the additional frame side member being particularly situated in parallel within a tolerance range. Such a specific embodiment offers the possibility of positioning the adaptive element between two frame side members. In this context, the adaptive element may have in each case at least one fastening point per frame side member. By tolerance range, one may understand, in this instance, a positioning of up to 45°, more favorably by up to 30°, more advantageously by up to 15°, more favorably still by up to 10°, or advantageously by up to 5° deviation from a parallel positioning.

It is also favorable if in one specific embodiment the structure of the adaptive element has a supporting device and a releasable die, the releasable die being developed in order to be brought from a first position into a second position upon activation of the actuator, the releasable die being developed to effect a higher rigidity in the first position of the adaptive element in comparison to the second position.

The releasable die may be developed in one piece in the form of a round or cornered frame, whose unobstructed inner dimension is at least partially less than a cross section of the deformation element before entry into a deformation section of the releasable die. The releasable die may be formed in one piece or be made up of several individual parts that are not connected to one another or connected via predetermined breaking point locations. The inner side or sides of the releasable die may run in a slanting manner, so that the releasable die forms a sort of funnel, which leads to the tapering of the deformation element, while the latter moves along on the inside of the releasable die because of the collision. By a releasable die one may understand a rigid die. The releasable die may be positioned in a housing in such a way that an outer wall of the releasable die is at a distance from an inner wall of the housing. The releasable die is able to be varied in its position. In particular, when support by the supporting device is lacking, the releasable die may be pushed away from the deformation element by the radial force of the penetrating deformation element, i.e. pressed towards the inner wall of the housing and perhaps broken, and thus not have the effect of any tapering of the deformation element. By a supporting device, one may generally also understand a breakable die.

The supporting device may be in one piece or several pieces, and may be positioned in the first position between the outer wall of the releasable die and the inner wall of the housing. It may be formed of a material which has a sufficient rigidity so as, in the first position, to support the releasable die in such a way against the radial force of the deformation element, moving along the inner side(s) of the releasable die, that the deformation element is able to be tapered by the releasable die. The supporting device may, for instance, be held fixed via a spring element in the first position or in the at-rest position.

Furthermore, according to one specific embodiment, the adaptive element may have a first housing part and a second housing part, the releasable die being developed to support the first housing part, in the first position, and the second housing part against each other and, in the second position, to permit a lesser deformation compared to the first position.

Corresponding to a further specific embodiment of the present invention, the adaptive element may be developed to enable a turning upside down and/or a folding and/or an abrasion and/or a destruction and/or a tapering and/or an expanding of at least one component of the adaptive element as a deformation method that is able to be triggered by the actuator. Thereby a technically very simple and thus cost-effective manner may be implemented in order to absorb the energy of the impact.

According to one specific embodiment of the present invention, the actuator is able to be developed as an electromechanical actuator and/or a pneumatic actuator and/or an hydraulic actuator and/or a magnetorheological actuator and/or a pyrotechnical actuator. Such a specific embodiment of the present invention also offers the possibility of a very cost-effective and effective implementation of an actuator.

Moreover, the adaptive element may also be developed to be rigidly connected to a chassis of a vehicle. This design approach has the advantage that the rigidity of the at least one frame side member, that is connected to the chassis of the vehicle via the adaptive element, may be increased in a simple manner. Such a specific embodiment especially permits a simple setting of the frame side member, in which buckling is not desired. This specific embodiment ensures a better support than a floating installation of the adaptive element.

Moreover, the adaptive element may also be developed to be situated in a floating manner with reference to a chassis of a vehicle. By a floating positioning one may understand, for example, a positioning in which the adaptive element is situated movably on the chassis of the vehicle within a range of motion. This does ensure an approximate arrangement of the adaptive element with reference to the chassis; however, by leaving open the exact position of the adaptive element with reference to the chassis, an unnecessarily costly assembly may be avoided. Such a specific embodiment of the present invention thus offers the advantage that it is easier and more cost-effective to implement, since there is no fixing to the chassis or the main bodywork.

No additional sensor system is required as sensor system by the design approach introduced here. Instead, the crash sensor system already present in the vehicle may be used. Of course, a sensor system especially developed for this approach may also be used. Consequently, as the actuator, one may use electromechanical, pneumatic, hydraulic, magnetorheological and pyrotechnical actuators. In this instance, the pyrotechnical solution has the advantage that is very favorable to implement, compared to the other actuators mentioned. The irreversibility, which such an actuator of necessity brings with it, is not a disadvantage in this case, since the ignition time is in the same range as that of an (irreversible) front air bag.

The present invention creates a method for activating a device for changing the rigidity of a vehicle, according to one of the preceding claims, the method having the following steps:

providing at least one impact signal, the impact signal representing a signal of at least one impact sensor;

ascertaining a type of impact and/or an impact severity while using the at least one impact signal; and

emitting a triggering signal in response to the ascertained type of impact and/or the ascertained impact severity, the triggering signal effecting an operation of the actuator of the adaptive element.

By an impact signal one may understand a signal of an impact sensor system. An impact sensor system may also be designated as a crash sensor system. The impact signal may also represent a signal which is detected by a special sensor system.

The present invention further creates a control unit that is developed to carry out or implement the steps of the method according to the present invention in corresponding pieces of equipment. The object on which the present invention is based is also able to be achieved quickly and efficiently by this particular embodiment variant of the present invention in the form of a control device.

In the case at hand, a control device is an electrical device which processes sensor signals and outputs control signals and/or data signals as a function thereof. The control device may have an interface, which may be developed as hardware and/or software. In a hardware development, the interfaces, for example, may be part of a so-called system ASIC, which includes all kinds of functions of the control device. However, it is also possible for the interfaces to be self-contained, integrated switching circuits or to be at least partially made up of discrete components. In a software design, the interfaces may be software modules which are provided in a microcontroller in addition to other software modules, for example.

Also advantageous is a computer program product which has program code that may be stored on a machine-readable carrier such as a semiconductor memory, a hard-disk memory or an optical memory, and which is used to carry out the method according to one of the specific embodiments described above when the program product is run on a computer, a device or a control unit. The computer program product may also be run on a control unit that is already present in the vehicle. Thus, the computer program product may be run in a crash control unit, for example.

### BRIEF DESCRIPTION OF THE DRAWINGS

FIG. 1 shows a schematic representation of the construction of a front end of an electric vehicle according to an exemplary embodiment of the present invention.

FIG. 2a shows a front end of an electric vehicle before an impact according to one exemplary embodiment of the present invention.

FIG. 2b shows a front end of an electric vehicle after an impact according to one exemplary embodiment of the present invention.

FIG. 2c shows a front end of a vehicle having an internal combustion engine, before an impact according to one exemplary embodiment of the present invention.

FIG. 2d shows a front end of a vehicle having an internal combustion engine, after an impact according to one exemplary embodiment of the present invention.

FIGS. 3a and 3b show a schematic representation of a front end structure having a device for changing the rigidity of a vehicle, according to one exemplary embodiment of the present invention.

FIG. 4 shows a schematic representation of a front end structure after an impact having partial overlapping according to an exemplary embodiment of the present invention.

FIG. 5 shows a schematic representation of a front end structure after an impact having full overlapping according to an exemplary embodiment of the present invention.

FIG. 6 shows an adaptive element between two frame side members according to an exemplary embodiment of the present invention.

FIG. 7 shows a flow chart of a method according to one exemplary embodiment of the present invention.

### DETAILED DESCRIPTION OF THE INVENTION

In the subsequent description of preferred exemplary embodiments of the present invention, the same or similar reference numerals are used for the elements that are shown in the various figures and act similarly, a repeated description of these elements having been dispensed with.

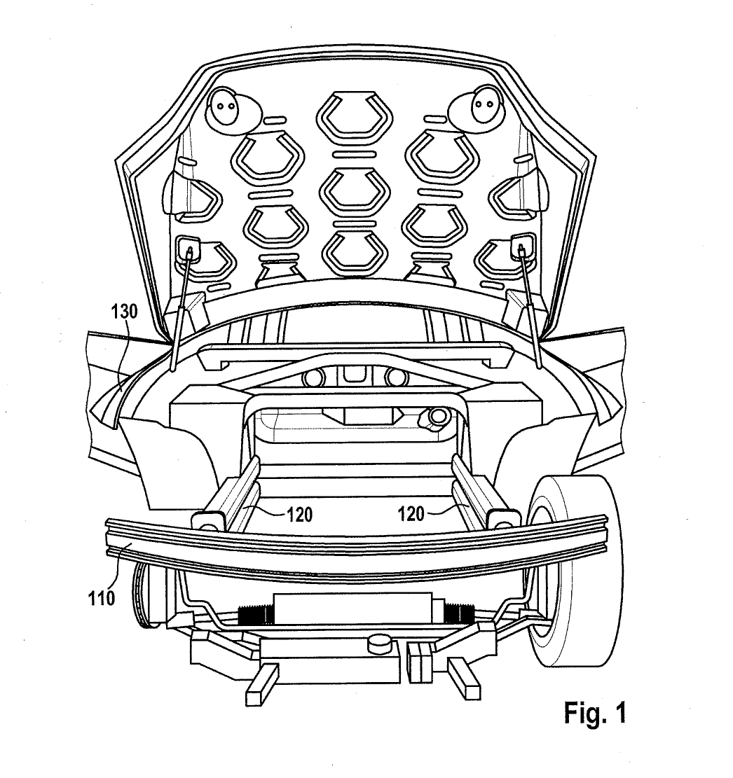

FIG. 1 shows a schematic representation of the construction of a front end of an electric vehicle according to an exemplary embodiment of the present invention. In FIG. 1, below a front cross member 110, an electric drive unit is shown having frame side members 120. Front cross member 110 is held by two frame side members 120. The two frame side members 120 are connected to chassis 130 of the vehicle. FIG. 1 shows that, due to the small numbers of assemblies in an electric vehicle, frame side members 120 are not additionally supported by assemblies in the front end of the vehicle.

In the construction of the front end of an electric vehicle shown in FIG. 1, it may be seen that the crash event of such an electric vehicle is clearly different from that of a conventional vehicle. Between the frame side members the space is almost empty, even if, of course, diverse coverings and other elements were to be taken into consideration. The electric motor is generally smaller and is located lower, and fewer assemblies are present, compared to a vehicle having an internal combustion engine. In the present example, however, a rear drive vehicle is involved, for which the above statement tends not to apply in general. The position and the size of the electric motor and/or additional assemblies have an enormous influence on the crash event, since in this case the inherent rigidity of the frame side members is of main importance.

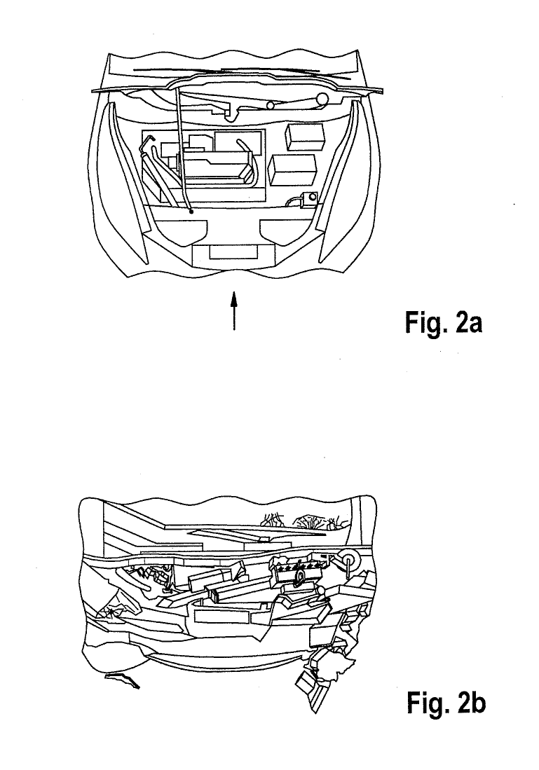

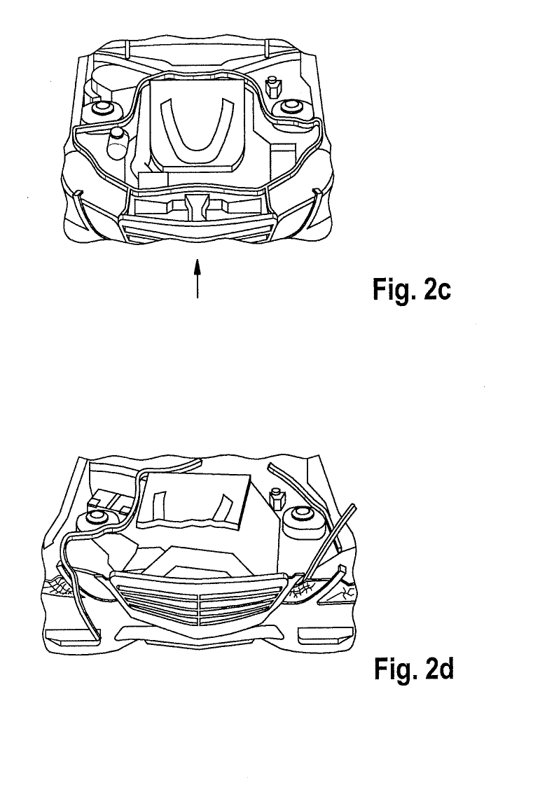

FIGS. 2a to 2d show the effects of an impact at 56 km/h on a rigid barrier having 100% overlap of the vehicle with the collision object, compared to an electric vehicle (FIG. 2a; FIG. 2b) to a vehicle having an internal combustion engine (FIG. 2c; FIG. 2d). FIGS. 2a and 2c show the situation before the impact and FIGS. 2b and 2d show the vehicle front end after the impact.

FIG. 2a shows a front end of an electric vehicle according to one exemplary embodiment of the present invention. The number of the assemblies in the engine compartment is smaller, and the arrangement of the assemblies is lower compared to the exemplary embodiment shown in FIG. 2c of a vehicle having an internal combustion engine. One technical deduction is that the frame side members, which are supposed to absorb the major portion of the crash energy, are more susceptible to buckling because of the lack of support in the front end. Thus, the frame side members should be dimensioned to be bigger/stiffer, in order to avoid uncontrolled buckling. Alternatively, their design should be selected so that they behave as unsusceptibly as possible to buckling. FIGS. 2a and 2b show a top view onto the engine compartment before the crash (FIG. 2a) and after the crash (FIG. 2b).

FIG. 2b shows a front end of an electric vehicle according to an exemplary embodiment of the present invention, after an impact at 56 km/h on a rigid barrier.

FIG. 2c shows a front end of a vehicle having an internal combustion engine, according to an exemplary embodiment of the present invention. The vehicle is shown in an intact state. A plurality of assemblies besides the internal combustion engine supports the frame side members and increases the rigidity of the front end.

FIG. 2c shows a front end of a vehicle having an internal combustion engine, according to an exemplary embodiment of the present invention. The vehicle has impacted a rigid barrier at 56 km/h. Because of the engine block situated in the front end, and the higher rigidity of the front end, that goes with it, in comparison in comparison to the electric vehicle shown in FIG. 2b, the vehicle is less deformed than the electric vehicle in FIG. 2b. FIG. 2c shows a top view onto the engine compartment before the crash, and FIG. 2d shows a top view onto the engine compartment after the crash.

Meanwhile, we have first results of crash tests using purely electric vehicles. In FIG. 2a and FIG. 2b, results are shown of a US-NCAP crash test (56 km/h against a rigid barrier having 100% overlap of the vehicle). When comparing FIGS. 2a/2b and FIGS. 2c/2d, it becomes clear that the deformation space rises clearly in comparison with conventional vehicles having an internal combustion engine in FIGS. 2c/2d, and the engine compartment is clearly buckled together after the crash. The figures are meant to show the visualization of the clearly changed deformation capability and the changed boundary conditions of electric vehicles. All this yields changed boundary conditions for the overall design of the front end structure.

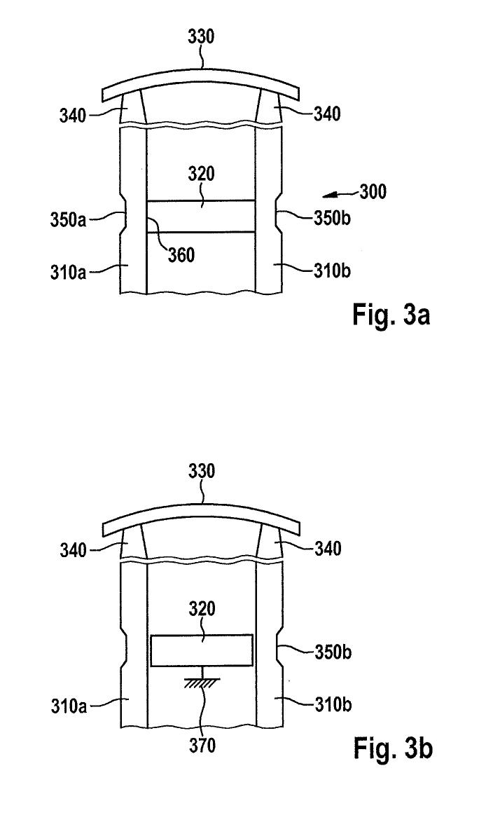

FIGS. 3a and 3b show a schematic representation of a front end structure according to one exemplary embodiment of the present invention. In this context, they differ from each other in their installation—FIG. 3a shows a floating installation and FIG. 3b a fixed installation of the adaptive element between two frame side members.

FIG. 3a shows a schematic representation of a front end structure having a device 300 for changing the rigidity of a vehicle, according to one exemplary embodiment of the present invention. The front end structure has two frame side members 310a, 310b, an adaptive element 320, a cross member 330 as well as two crash boxes 340. The two frame side members 310a, 310b are situated in parallel, in a tolerance range. The tolerance range amounts to 10° in the exemplary embodiment shown. In additional exemplary embodiments, the tolerance range may amount to up to 45°. The two frame side members 310a, 310b are connected to each other via adaptive element 320. The main direction of extension of the two frame side members 310a, 310b corresponds essentially to the travel direction of the vehicle. Frame side members 310a, 310b each have a crash box 340 at their end that lies in front in the travel direction. Crash boxes 340 situated at the ends of frame side members 310a, 310b are connected to each other via cross member 330. In the region of the fastening of adaptive element 320, the two cross members 310a, 310b each have a section 350a or 350b for an intended buckling in. In the exemplary embodiment shown in FIG. 3a, section 350 is carried out as a weakening for a targeted buckling in, by way of tapering the frame side member in the contact region having adaptive element 320. Adaptive element 320 is connected to frame side members 310a, 310b, in each case via a contact point 360.

FIG. 3b shows a schematic representation of a front end structure according to an additional exemplary embodiment of the present invention. The front end structure of the vehicle has two frame side members 310a, 310b, an adaptive element 320, a cross member 330 as well as two crash boxes 340. The two frame side members 310a, 310b are situated essentially in parallel. The two frame side members 310a, 310b are connected to each other via adaptive element 320. The design extensively corresponds to the illustration in FIG. 3a, the difference being that adaptive element 320 is rigidly connected to chassis 370 of the vehicle. In the area of the contact point with adaptive element 320, that is, section 350, the two cross members each have tapering, that is, the cross section of the frame side members has a smaller cross section in this section. The adaptive element at the center has an additional contact point with chassis 370.

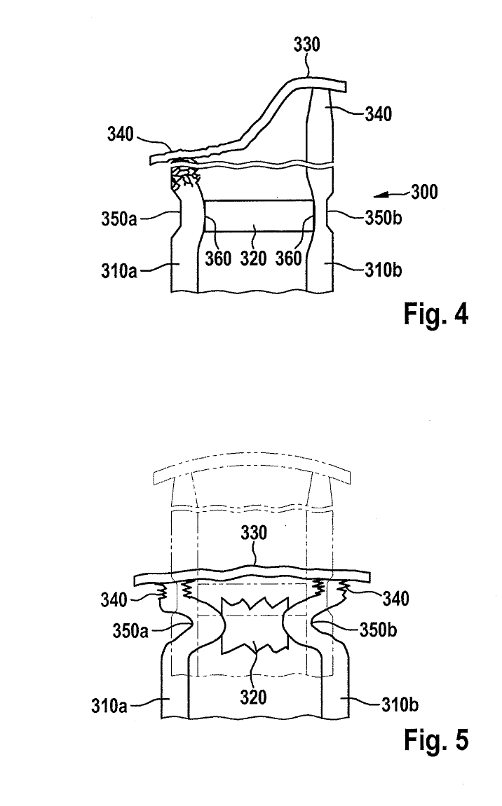

For the representation in FIG. 3a and FIG. 3b, it is true that the adaptive element is set differently depending on the crash requirement. If a severe crash is involved having partial overlapping (e.g. Euro-NCAP), the crash energy is typically absorbed via a single frame side member 310a, 310b. Since the folding (compression) of an object in a crash basically leads to a greater energy absorption, and, with that, leads to a higher speed reduction than a bending process, buckling (i.e. bending of frame side members 310a, 310b) should be avoided in this case. For this, the adaptive element has to be connected as rigidly as possible. This is shown correspondingly in FIG. 4. If a severe crash is involved having full overlapping (e.g. US-NCAP), the crash energy is absorbed via both frame side members 310a, 310b. Too rigid a structure would lead to an hard crash pulse, which would mean a higher risk of injury for the passenger. Since in this crash case both frame side members 310a, 310b absorb the crash energy, the corresponding crash load is divided into two load paths, with which it is connected that the individual frame side members 310a, 310b are able to behave “softer” overall. In this case, the bending or buckling should be selected as an additional deformation method for frame side members 310a, 310b. In addition, adaptive element 320 between frame side members 310a, 310b has to be set to a lower rigidity, as is shown correspondingly in FIG. 5.

If a repair crash is involved (speed up to 16 km/h), as seen structurally in conventional vehicles, only crash boxes 340 and cross member 330 are damaged. Adaptive element 320 is not damaged, which does not push up the repair costs additionally. The present concept assumes that standard crash boxes 340 for this case are installed in front of the vehicle or alternative provisions are used for reproducing the repair crash.

FIG. 4 shows a schematic representation of a front end structure after an impact having partial overlapping according to one exemplary embodiment of the present invention. The front end structure of the vehicle has two frame side members 310a, 310b, an adaptive element 320, a cross member 330 as well as two crash boxes 340. Before the impact, the structure corresponded to that in FIGS. 3a and 3b. Upon an impact having partial overlapping, no buckling is desired in frame side member 310a. The rigidity set in adaptive element 320 is set to an higher rigidity. The illustration shown corresponds to a frontal impact at a partial overlapping of the left side of the vehicle. Crash box 340, which is situated between cross member 330 and frame side member 310a is completely deformed. Cross member 330 is correspondingly deformed, and continues to connect the two crash boxes 340. Frame side member 310a situated on the left, in its front section between crash box 340 and section 350a, in which frame side member 310a is tapered, is buckled, or rather is shortened with respect to the original extension corresponding to FIGS. 3a, 3b, or in comparison to undamaged frame side member 310b on the right.

FIG. 4 shows a deformed vehicle structure in the case of an offset crash according to an exemplary embodiment of the present invention. In a situation corresponding to FIG. 4, that is, in the setting in which buckling is not desired, a rigid construction as shown in FIG. 3b is of advantage, since, in that way, a better support is ensured. In the case of a desired buckling as in FIG. 5, the method of installation has no functional importance. To be sure, the design in FIG. 3a is easier and more cost-effective to implement, since there is no fixing to the main bodywork.

FIG. 5 shows a schematic representation of a front end structure after an impact having full overlapping according to an exemplary embodiment of the present invention. The front end structure of the vehicle has two frame side members 310a, 310b, an adaptive element 320, a cross member 330 as well as two crash boxes 340. Before the impact, the structure corresponded to that in FIGS. 3a and 3b. The shape of the vehicle's front end before the impact having full overlapping is shown by broken lines. In the illustration in FIG. 5, the two crash boxes 340 have been pressed together because of the energy absorbed. In comparison with the illustration in FIGS. 3a/3b, adaptive element 320 is shortened and the two frame side members have buckled inwards in the area of the contact point with adaptive element 320. Furthermore, frame side members 310a, 310b have been shortened in the section between the connection to crash box 340 and the contact point with adaptive element 320. Cross member 330 is largely unchanged in its shape, in comparison to FIGS. 3a/3b, but is closer to the middle of the vehicle, which is shown as being lower in FIG. 5. This is owing to the deformation of the two crash boxes 340 and of frame side members 310a, 310b.

FIG. 5 shows a deformed vehicle structure in the case of a fully frontal crash. What is shown is a changeable rigidity of a front section structure, particularly for a vehicle concept such as hybrid vehicles, electric vehicles or small or light vehicles. The manner of functioning of adaptive element 320 is able to be optional in this context, as long as different rigidities are implementable. As deformation method, one may draw upon turning upside down, folding, abrasion, crumbling, tapering or expanding.

One idea of the present invention is to permit a controlled deformation of the frontal structure during a frontal crash. In this context, the buckling behavior of frame side members 310a, 310b is adapted to the type of crash and the severity of the crash, particularly in the case of vehicles having less rigid and stiff assemblies in the front section (e.g. electric vehicles). It is one further idea of the present invention to create more variation possibilities in the design of the front end structure, during the development and introduction of new vehicle concepts.

The buckling behavior of frame side members 310a, 310b is influenced using an adaptive element 320 between frame side members 310a, 310b. Adaptive element 320 is installed transversely between the two frame side members 310a, 310b, according to FIGS. 3a/3b. With that, an adaptation takes place of the lateral rigidity between the individual frame side members 310a, 310b. The installation is able to take place in a floating manner (see FIG. 3a) or rigidly (see FIG. 3b). With that, adaptive element 320 jointly also advantageously takes over the function of transverse stabilization of the front of the car based on the missing rigid mass and geometry of an internal combustion engine block (as in conventional vehicles. The transverse stabilization is not only necessary for the optimal crash design of the structure, but is also important in the NVH design (noise, vibration, harshness) of the vehicle, cf. torsional rigidity.

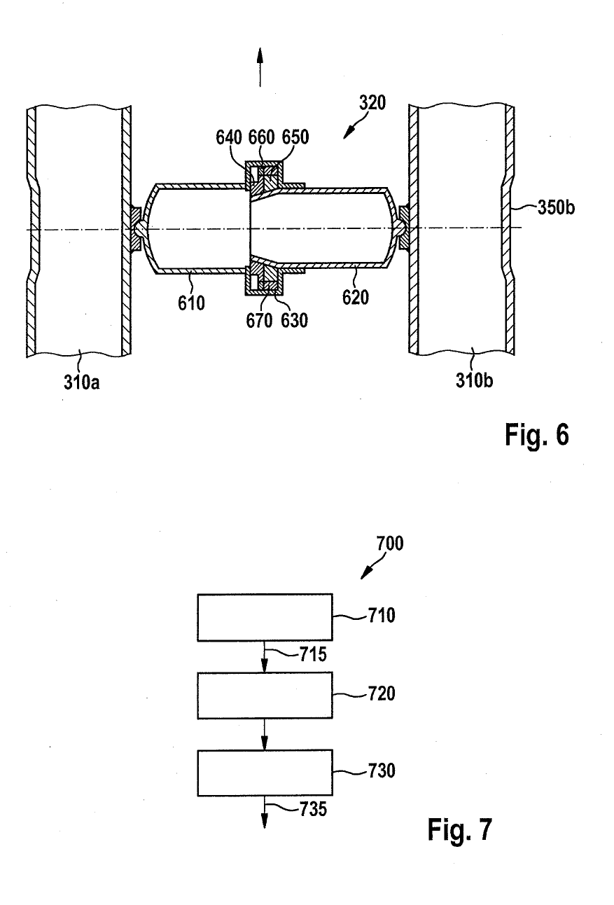

FIG. 6 shows an adaptive element between two frame side members according to an exemplary embodiment of the present invention. An adaptive element 320 is positioned between two frame side members 310a, 310b. Adaptive element 320 has a first housing part 610, in this case a rigid bell 610, a second housing part 620, in this case a deformable bell 620, as well as a supporting device 640 situated in a housing 630, a releasable die 650, a ring 660 and a pyrotechnical actuator 670. Supporting device 640 may also be designated as a breakable die 640, the releasable die 650 also as a rigid die 650. First housing part 610 has a contact point to frame side member 310a situated on the left. Second housing part 620 has a contact point to frame side member 310b situated on the right. Second housing part 620 tapers on the side facing first housing part 610. In the area of the transition between first housing part 610 and second housing part 620, adaptive element 320 has housing 630. Supporting device 640, releasable die 650, ring 660 as well as pyrotechnical actuator 670 are situated within housing 630. Supporting device 640 is L-shaped. Ring 660 is situated on an upper leg of supporting device 640. With reference to the main extension direction of adaptive element 320, releasable die 650 is situated next to supporting device 640, in the direction of second housing part 620. Supporting device 640 and releasable die 650 are formed and situated laterally flush with each other. Pyrotechnical actuator 670 is situated between releasable die 650 and housing 630. Releasable die 650, ring 660 and supporting device 640 are situated in such a way that, in response to an activation of pyrotechnical actuator 670, the ring is displaced in the direction of first housing part 610, and thus into the open region of deformable die 640. After an activation of pyrotechnical actuator 670, second housing part 620 may be displaced more easily into housing part 610.

A constructive form of adaptive element 320 is shown in exemplary fashion in FIG. 6. In this case, the tapering principle is sketched as the deformation and the pyrotechnical actuator is sketched as the actuator. FIG. 6 shows one possible design of an adaptive element 320 between frame side members 310a, 310b.

FIG. 6 shows the at-rest position of the system. In the case of a collision, the front end region of the vehicle that is not sketched is pressed in. In the process, the sensing takes place of the crash severity and the crash type. Depending upon the requirement, the tapering of deformable bell 620 takes place more or less strongly. In the setting shown, deformable bell 620 is pushed into rigid die 650 and into breakable die 640 and is thereby strongly tapered. As a result, buckling of frame side members 310a, 310b should not take place in this case. During an actuation (explosion) of firing pellets 670, ring 660 is displaced in the direction of rigid bell 610. Now, if there is a deformation of adaptive element 320, deformable bell 620 also penetrates into rigid die 650 and into breakable die 640. Since the ring is not supporting breakable die 640, the latter is able to break (breaking point locations) and be released as a result of the impression of a radial force by deformable bell 620. The degree of tapering of deformable bell 620 is thus less, compared to the basic setting, and it is able to be “tapered into” rigid bell 610 which, in the final analysis, favors the buckling of frame side members 310a, 310b.

Depending on the transverse distance of frame side members 310a, 310b from each other, a weight-saving implementation suggests itself, in which the rigid bell and deformable bell 620 are not connected directly to frame side members 310a, 310b, but rather to appropriate extension carriers or braces optimized for light construction.

FIG. 7 shows a flow chart of a method according to one exemplary embodiment of the present invention. Method 700, for activating a device for changing the rigidity of a vehicle, has a step of providing 710, a step of ascertaining 720 and a step of emitting 730. In the step of providing 710, at least one impact signal 715 is provided, impact signal 715 presenting a signal of at least one impact sensor signal. In the step of ascertaining 720, an impact type and/or an impact severity is ascertained while using the at least one impact signal 715. In the step of emitting 730, a triggering signal 735 is emitted in response to the ascertained type of impact and/or the ascertained impact severity, triggering signal 735 effecting an operation of the actuator of the adaptive element.

The exemplary embodiments described and shown in the figures have been selected merely as examples. Different exemplary embodiments are combinable with one another, either completely or with regard to individual features. An exemplary embodiment may also be supplemented by features from another exemplary embodiment.

Furthermore, method steps according to the present invention may be carried out repeatedly and also performed in a sequence other than the one described.

If an exemplary embodiment includes an “and/or” linkage between a first feature and a second feature, this may be understood to mean that the exemplary embodiment according to one specific embodiment has both the first feature and the second feature, and according to an additional specific embodiment, either has only the first feature or only the second feature.

1-12. (canceled)

13. A device for changing the rigidity of a vehicle, comprising:
at least one frame side member;
an adaptive element having at least two fastening points, at least a first fastening point of the at least two fastening points being connected to the at least one frame side member, the adaptive element being aligned transversely to the at least one frame side members, and the adaptive element having an actuator including an interface for receiving a triggering signal for operating the actuator, wherein the actuator is configured to change the rigidity of the adaptive element in response to the triggering signal.

14. The device as recited in claim 13, wherein the at least one frame side member includes a first section which has a lesser rigidity compared to a second section of the at least one frame side member.

15. The device as recited in claim 14, wherein a second fastening point of the at least two fastening points is connected to an additional frame side member, the at least one frame side member and the additional frame side member being situated substantially in parallel.

16. The device as recited in claim 14, wherein the structure of the adaptive element has a supporting device and a releasable die, the releasable die being configured to be selectively switched from a first position into a second position upon the activation of the actuator, the releasable die providing a higher rigidity of the adaptive element in the first position in comparison to the second position.

17. The device as recited in claim 16, wherein the adaptive element has a first housing part and a second housing part, and wherein the releasable die (i) supports the first housing part and the second housing part against each other in the first position and (ii) facilitates an easier deforming in the second position in comparison to the first position.

18. The device as recited in claim 14, wherein the adaptive element is configured to enable at least one of a turning upside down, a folding, an abrasion, a destruction, a tapering, and an expanding of at least one component of the adaptive element in response to the triggering of the actuator.

19. The device as recited in claim 18, wherein the actuator is at least one of an electromechanical actuator, a pneumatic actuator, a hydraulic actuator, a magnetorheological actuator, and a pyrotechnical actuator.

20. The device as recited in claim 14, wherein the adaptive element is configured to be rigidly connected to a chassis of a vehicle.

21. The device as recited in claim 14, wherein the adaptive element is configured to be situated in a floating manner with respect to a chassis of a vehicle.

22. A method for activating a device for changing the rigidity of a vehicle, the device including at least one frame side member, and an adaptive element having at least two fastening points, at least a first fastening point of the at least two fastening points being connected to the at least one frame side member, the adaptive element being aligned transversely to the at least one frame side members, and the adaptive element having an actuator including an interface for receiving a triggering signal for operating the actuator, wherein the actuator is configured to change the rigidity of the adaptive element in response to the triggering signal, the method comprising:
providing at least one impact signal from at least one impact sensor;
ascertaining at least one of a type of impact and an impact severity based on the at least one impact signal; and
emitting a triggering signal in response to the at least one of the ascertained type of impact and the ascertained impact severity, wherein the triggering signal triggers an operation of the actuator of the adaptive element.

23. A non-transitory, computer-readable data storage medium storing a computer program having program codes which, when executed on a computer, performs a method for activating a device for changing the rigidity of a vehicle, the device including at least one frame side member, and an adaptive element having at least two fastening points, at least a first fastening point of the at least two fastening points being connected to the at least one frame side member, the adaptive element being aligned transversely to the at least one frame side members, and the adaptive element having an actuator including an interface for receiving a triggering signal for operating the actuator, wherein the actuator is configured to change the rigidity of the adaptive element in response to the triggering signal, the method comprising:
providing at least one impact signal from at least one impact sensor;
ascertaining at least one of a type of impact and an impact severity based on the at least one impact signal; and
emitting a triggering signal in response to the at least one of the ascertained type of impact and the ascertained impact severity, wherein the triggering signal triggers an operation of the actuator of the adaptive element.
